(19) United States
(12) Patent Application Publication
(10) Pub. No.: US 2022/0173994 A1
(43) Pub. Date: Jun. 2, 2022

(54) CONFIGURING OPERATIONAL ANALYTICS

(71) Applicant: Hewlett-Packard Development Company, L.P., Spring, TX (US)

(72) Inventors: Daniel Cameron Ellam, Bristol (GB); Adrian John Baldwin, Bristol (GB); Jonathan Francis Griffin, Bristol (GB)

(73) Assignee: Hewlett-Packard Development Company, L.P., Spring, TX (US)

(21) Appl. No.: 17/417,132

(22) PCT Filed: Aug. 16, 2019
(86) PCT No.: PCT/US2019/046778

§ 371 Date: Jun. 22, 2021

(51) Int. Cl. H04L 43/50; G06F 11/30

(52) U.S. Cl. CPC H04L 43/50; G06F 11/3006

(57) ABSTRACT

Configuring analytics to be performed at an endpoint device, comprising receiving at least one analytic input determined from instrumented processes operated at the endpoint device, performing at least one analytic of a set of analytics stored in the endpoint device, to produce a respective analytic output, transmitting the at least one analytic output to the server, receiving, from the server, at least one analytics configuration update, based on measures indicative of the usefulness of the analytics calculated at the server, to reconfigure at least one of the set of analytics stored in the endpoint device. Based on the received analytics configuration updates, the endpoint device reconfigures at least one of the set of analytics by at least one of: stopping or starting performing the analytic, and tuning how the analytic is performed.

### BACKGROUND

With the recent expansion of cloud-based services (e.g. Device as a Service (DaaS), Platform as a Service (PaaS), 3D as a Service (3DaaS), Managed Print Services (MPS) etc.) to include increasing numbers of connected devices both user devices and machine devices and where increasing numbers and types of 3rd party ‘apps’ and plugins are being installed on the connected devices (e.g. InTune, JetAdvantage Link), there is an increasingly greater variety and quantity of external network traffic and data from the connected devices, including more opportunities for vulnerabilities & malware.

### BRIEF INTRODUCTION OF THE DRAWINGS

Examples of the disclosure are further described hereinafter with reference to the accompanying drawings, in which:

FIG. 1 shows a cloud computer system;

FIG. 2 shows an example of a cloud server in the cloud computer system of FIG. 1;

FIG. 3 shows an example of an endpoint device in the cloud computer system of FIG. 1;

FIG. 4 is a schematic showing the types of communications exchanged between a fleet of endpoint devices and a server in the cloud computer system;

FIG. 5 is a schematic showing an example of the analytics sent from a fleet of endpoint devices to a server in the cloud computer system;

FIG. 6 shows a flowchart of an example method carried out by a server in the cloud computer system.

FIG. 6 shows a flowchart of an example method carried out by an endpoint device in the cloud computer system.

### DETAILED DESCRIPTION

For cloud-based services it is becoming more and more important to be able to spot malicious behaviours effectively, run analytics, and take advantage of fleet-wide and cross-fleet information but without losing the benefits of fast edge-based detectors.

A cloud computing device such as a virtualized server can support the deployment and operation of multiple connected endpoint devices, which may be provided, for example, for the benefit of enterprise users carrying out their functions in an operational environment. To facilitate or automate aspects of the management and operation of the endpoint devices, a cloud server may monitor analytics for each device, which may be produced in full or in part at the device or the cloud server based on input data provided by the endpoint devices. Each analytic may provide a measure indicating an operational performance of the endpoint device based on the analytic inputs. Analysis of the analytics by the cloud server to identify problems with operational effectiveness of one or more of the devices, such as arising from an attempted security breach, may allow manual or automated interventions on the configuration and management to change their operation and address the operational problem. This can simplify and significantly improve the maintenance of the operational effectiveness and security of those devices without requiring manual intervention.

However, such management of a fleet of endpoint devices by a cloud-based computing infrastructure can incur significant cost overheads and opportunity costs in CPU time, network bandwidth utilisation, and storage, especially in domains such as monitoring the devices for cyber security challenges, where it may be necessary to perform many process intensive analytics and generate and transmit large quantities of data. Yet, equally, performing analytics and processing data at the endpoint devices also incurs a large cost, especially for battery-powered devices, which have an impact on the performance of the device that is noticeable by a user.

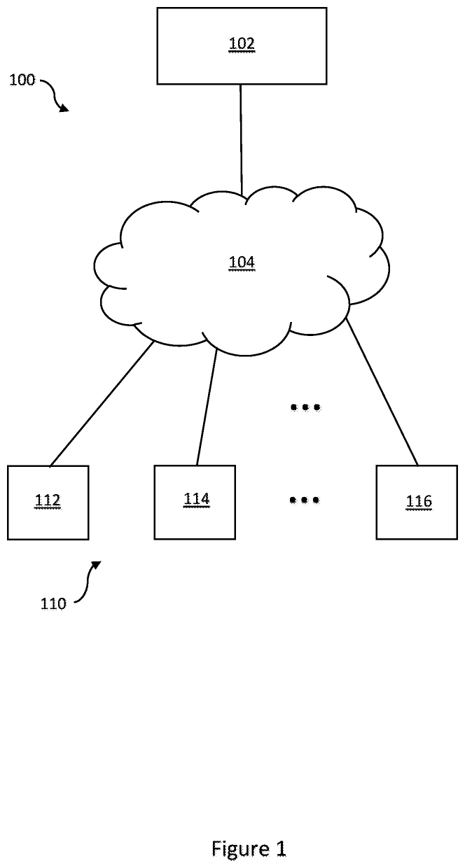

FIG. 1 shows a cloud computer system 100 which comprises at least one server 102, also referred to as cloud servers or the cloud backend, in communication with a fleet 110 of endpoint devices 112, 114 and 116, also referred to as endpoints. The cloud server 102 may represent one or more instances of virtualised servers instantiated in a hypervisor operating across one or more physical servers in one or more data centres. The cloud server(s) 102 and the endpoint devices 112, 114, 116 of the fleet 110 communicate with each other via a network 104, such as the internet. The endpoint devices 112, 114 and 116 of the fleet 110 may be located in the same local network, with the same IP address, or they may be located at separate locations with different IP addresses. The endpoint devices 112, 114 and 116 may be managed by the cloud server(s) 102.

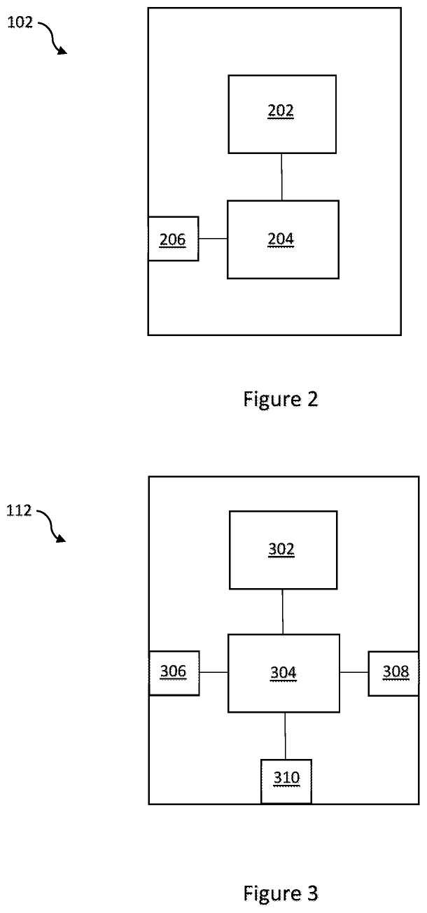

FIG. 2 shows an example of a server 102 that may be part of the cloud backend of the cloud system 100 of FIG. 1. The server 102 comprises a memory 202, a processor 204, and a communication unit 206.

The memory 202 may be any electronic, magnetic, optical, or other physical storage device that stores executable instructions, which when executed by the processor 204, cause the server to perform any of the methods described herewith as being carried out by a server, cloud server or cloud backend. The communication unit 206 allows the server 200 to transmit and receive communications with other devices directly or via a network 104 such as the internet, for example, to receive analytics and other data from a fleet of endpoint devices, and, in examples of the disclosure transmit updates to the fleet of endpoint devices.

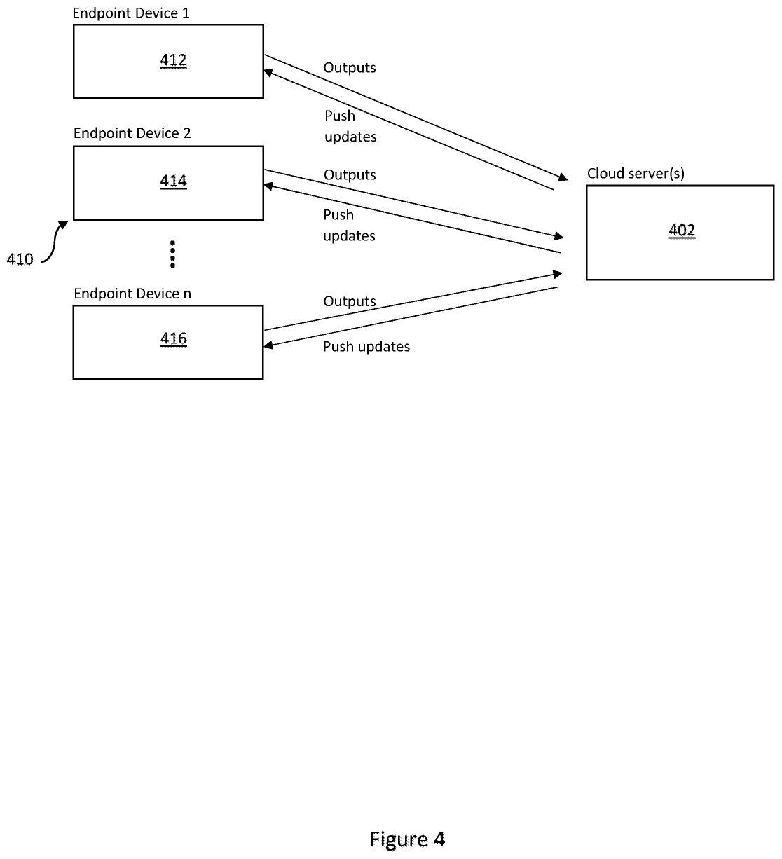

FIG. 3 shows an example of an endpoint device 112 that may be part of the fleet of endpoint devices 110 in the cloud system 100 of FIG. 1. The endpoint device 112 comprises a memory 302, a processor 304, a communication unit 306, a sensor 308 and a user interface 310.

The memory 302 may be any electronic, magnetic, optical, or other physical storage device that stores executable instructions, which when executed by the processor 304, cause the endpoint device to perform any of the methods described herewith as being carried out by an endpoint device or endpoint. The memory 302 may store one or more analytics configured on the device 112 at set up and deployment of the device or subsequently by configuration by the server 102. Each analytic may be a function modelling as the analytic output a measure indicating an operational performance of the endpoint device based on at least one analytic input determined from instrumented processes operated at the endpoint device. The communication unit 306 allows the endpoint device 112 to transmit and receive communications with other devices directly or via a network 104 such as the internet, and, in examples of the disclosure, to receive updates from the cloud server and transmit analytics data to the cloud server. The sensor 308 allows the endpoint device 112 to measure an instrumented process on the endpoint device 112 and produce analytic inputs. An example analytic input is the amount of data transmitted from the endpoint device 112 via the communication unit 306. The sensor 308 may be a software implemented process in the device that monitors and receives inputs from instrumented processes operated by the device. The data provided by the sensor 308 may be used to provide inputs for analytics, the processing of which may be performed in full or in part by the processor 304 at the endpoint device 112. The user interface 310 allows a user to interact with the endpoint device, and may comprise, for example, a touch screen or a keyboard.

In cloud server device management systems, the endpoint devices could send the raw or part-processed sensed analytic inputs to the cloud server for processing to provide the analytics, or to perform the analytics locally at the edge of the network and transmit the analytic outputs to the cloud server.

It is possible to operate such analytics processing using all the analytics configured on the endpoint devices continually. Such systems would process all of the analytic input data they sensed, and send all the processed analytics to the cloud server continually. This would be the case regardless of the usefulness of the analytics to the management of the devices, or the cost to the system of producing the analytics. However, the analytics may be suboptimal, due to, for example, redundancy in the input data or analytics increasing over time as the operational environment changes. Further, over time, new inputs combinations thereof may provide more useful information for device management.

Methods and apparatuses described herein seek to address the improvement of the analytics implemented in a fleet of endpoint devices over time by intelligently analyzing them and causing their configuration at the endpoint devices to be changed.

For example, it is sometimes the case that processing all the analytic inputs configured for producing all the analytics across all the endpoint devices is sub-optimal. For example, some of the analytic inputs or analytics may provide less useful information than others and so processing them is not worthwhile. Equally, some of the analytic inputs and analytics may be more useful than others at a given time, and so updating the configuration of the analytics and the analytic inputs used to produce them can lead to benefits in effectiveness of device management (e.g. sensitivity to cyber threats) and also in processing time and other device costs. This is true for either the data input to the edge analytics or indeed the output of the analytics collected at the cloud.

In addition, being selective about a given analytic algorithm's configuration given the observed analytic input data through dynamically updating the choice of values for the algorithm's hyperparameters may lead to more useful analytic outputs and better decisions based on this observed analytic input data. Selective processing of certain features is dynamic, and thus may also include reinstatement of a feature previously excluded from consideration.

Thus, methods, apparatuses and cloud computing systems are disclosed herein whereby utility functions are used to ascertain benefits and costs to the system of the inclusion in the analytics configured to be performed by the endpoint devices of different analytic inputs, different analytics, or different hyperparameters chosen in producing the analytics. The system coordinates the endpoints in a way as to process just some subset of possible data features as per the utility functions, and conversely the system is able to explore the potential benefit of including different features, not currently used in the production of the analytics at the devices.

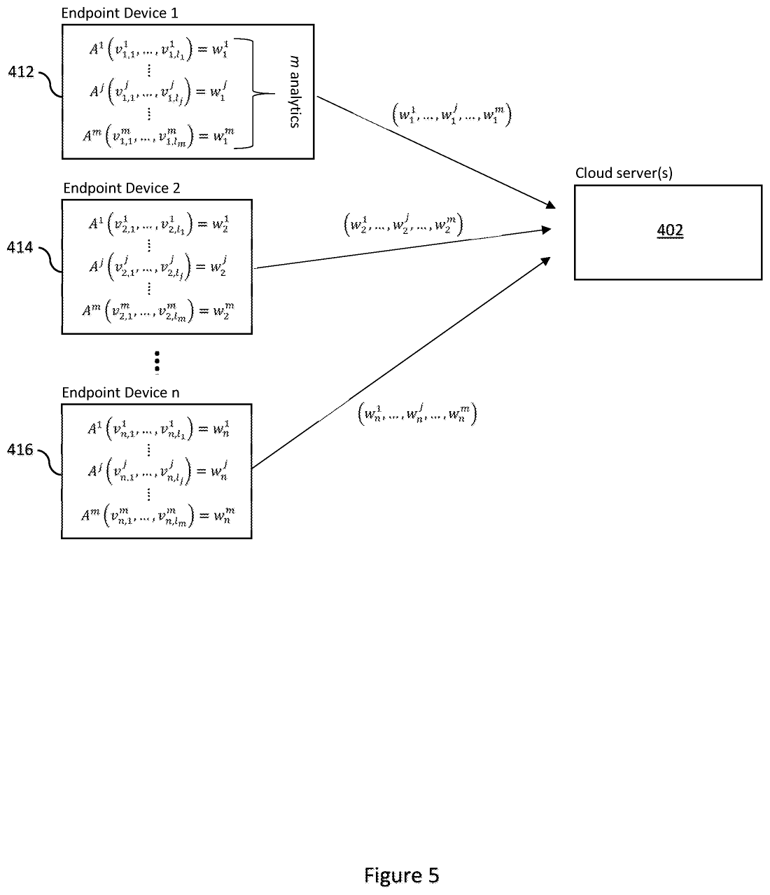

As will be evident from the description in relation to FIGS. 4-8, in examples of the present disclosure the configuration of the analytics is updated over time to aid the reduction of the data processing and transfer costs both at the endpoint devices and the cloud server in producing analytics that are useful for the management of the endpoint devices in their operational environment. That is, in examples of the present disclosure, the cloud server provides analytics configuration updates to the endpoint devices to optimize the sensitivity and effectiveness of the device management through the generation and monitoring of the analytics, while limiting the processing burden on the system of producing and transferring those analytics to the cloud server.

Further, as the nature of the operational environment in which the endpoint devices are situated leads to changes in the input data ingested by the analytics, the characterization of the operational performance of the devices in the operational environment by the analytics may change over time. Were the configuration of the analytics to remain unchanged in this changing environment, this would lead to changes in sensitivity of the analytics, causing to them become sub-optimal in terms of the usefulness of the information they deliver to the cloud server for managing the fleet of devices and the cost associated with producing the analytics across the fleet and transferring the analytics data to the cloud server. Thus, as will be evident from the following described examples, the present disclosure provides methods and apparatuses for updating the configuration of the analytics at the fleet of endpoint devices to maintain, optimize or improve their usefulness in sensing the changing operational environment and to manage the cost of producing and transferring the analytics to the cloud server.

Further, when performing data analysis, for example for producing the configuration of analytics, overfitting of the analytics can occur when different analytics or inputs used to produce the analytics become highly correlated, for example due to changes in the environment in which the endpoint devices operational. As will be evident from the following description, example analytics configuration methods and systems of the present disclosure help to reduce the effects of this overfitting and redundancy in the analytic outputs and improve the performance of the analytics.

Referring now to FIG. 4, an example setup of a cloud computer system 100 in accordance with the present disclosure is shown to illustrate the types of communications generally exchanged between a fleet of endpoint devices 410 and the cloud backend 402. The endpoint devices 412, 414 and 426 illustrate the population of endpoint devices in the fleet 410, executing a number of analytics. Such analytics may be rules, machine learning based approaches, anomaly detection, and so on, and in this system the endpoint devices 412, 414 and 416 are connected to a cloud backend 402. The endpoint devices 412, 414 and 416 may be printers or PCs or some other endpoint devices, and the communication with the cloud 402 is two-way, which allows the endpoints 412, 414 and 416 to send analytics data to the cloud 402, and receive updates and instructions back from the cloud 402.

The analytics performed by the endpoint devices 412, 414 and 416 process data which may be raw data from instrumenting some process on the endpoint device 412, 414 and 416, or the data may have first been through pre-processing including other analytics or summarisation processes. The output from the analytics is sent to a cloud computer system 402 where further downstream analysis may take place.

The cloud 402 sends push updates to the fleet of endpoint devices 410 to cause the endpoint devices to change the configuration of one or more of the analytics configured on the devices 410. The changes to the configuration of the analytics may be based on analysis of the analytics performed at the cloud server 402 to, for example, optimise the balance between the usefulness of the information gained from an analytic in managing the devices in the fleet 410, and the processing and bandwidth costs (to the devices 410 and/or the server 402) associated with performing the analytic. In this way, the analytics may be periodically reconfigured to achieve improved return of useful information for managing the devices in their operational environment, and reduced resource burden on the system for producing and transmitting the analytics. Such updates typically occur in a time scale of days or weeks, but may also be triggered or overridden by human operators on a temporary basis, if, for example, there is concern of a cyber attack. The cloud server 402 may also periodically send in the updates new analytics to the fleet of endpoint devices 410 that better detect new malware and/or anomalies, although this occurs less frequently.

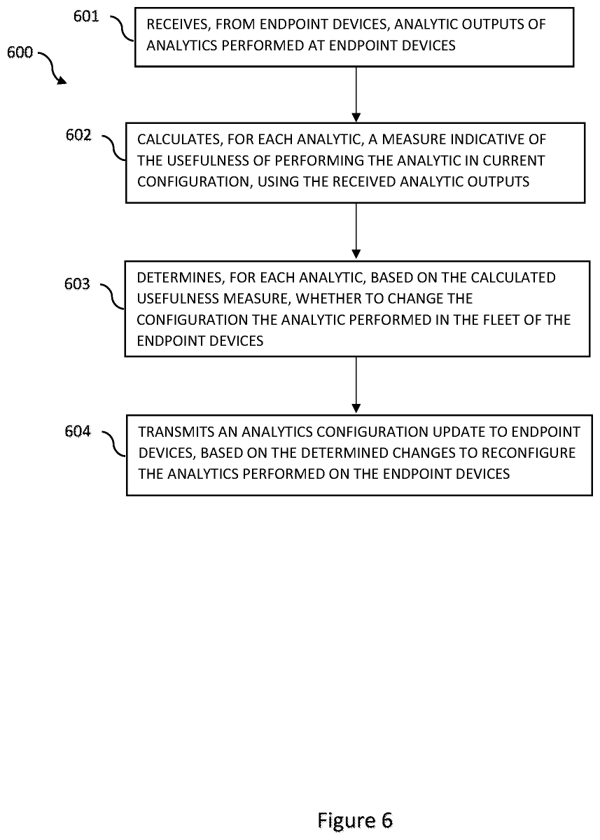

FIG. 5 is a schematic diagram of the cloud computer system 100 that is similar to FIG. 4, but shows generally the analytics that are provided to the endpoint devices 412, 414 and 416 that may be performed by the endpoint devices 412, 414 and 416, and the analytic outputs from those analytics that may be transmitted to the cloud server 402. With reference to FIG. 5, general notations and mathematic relationships will also be introduced to define the analytics and analytics data, and these will continue to be used hereafter. Specific examples of analytics and analytics data that might be used in the cloud computer system are described later on the description.

In the example of FIG. 5, there are n endpoint devices in the fleet, of which three are shown 412, 414 and 416, in communication with at least one cloud server 402, like in FIG. 4.

The n endpoint devices are shown performing the same m analytics, A^{j}, 1≤j≤m.

In one configuration, each analytic, A^{j}, may be performed locally at each of the n endpoint devices. In another configuration, one or more analytics A^{j} may be performed only on a subset of the n endpoint devices, depending on how the endpoint device is configured by the server 402.

Each analytic A^{j} operates on some input vector (v₁^{j}, vₗ_{ⱼ}^{j}) of length lⱼ, where vᵢ^{j} represents input data, also referred to an analytic input, and as a result, each analytic A^{j} produces a respective output w^{j}. Each analytic may also contain or be configurable in their operation by parameters or hyperparameters A_{α}^{j}, A_{β}^{j} etc. whose values may be chosen to affect how analytic A^{j} is performed.

The analytic inputs are received locally at each of the endpoint devices performing the analytic. To refer to specific analytic inputs received at a particular endpoint device k for being acted on by analytic A^{j}, the notation (v_{k,1}^{j}, v_{k,2}^{j}, . . . , v_{k,l}_{ⱼ}^{j}) is used. To refer to a specific analytic output produced at a particular endpoint device k performing analytic A^{j}, the notation wₖ^{j}, is used. Note that the general notations (v₁^{j}, v₂^{j}, . . . , vₗ_{ⱼ}^{j}) and w^{j}, without the reference to a specific endpoint device, may be used to refer to the inputs or outputs across many endpoint devices, but may also refer to the inputs and outputs on a specific endpoint device, which will be made clear from the context.

The input vector (v₁^{j}, . . . , vₗ_{ⱼ}^{j}) for performing analytic A^{j} may be the same for each endpoint device performing analytic A^{j}, or it might vary from endpoint device to endpoint device performing the analytic A^{j}, depending on local considerations. For example, an endpoint device performing Aⱼ may not be able to receive one or more particular analytic input, say v₁^{j}, from the input vector (v₁^{j}, . . . , vₗ_{ⱼ}^{j}), but may still be able to perform the analytic A^{j} on input vector (v₂^{j}, . . . , vₗ_{ⱼ}^{j}) to produce a useful output for analytic A^{j}.

Thus, generally, in a fleet of n endpoint devices, each performing analytics from a set of m analytics, in order to specify a particular analytic A^{j}, 1≤j≤m being performed on endpoint device k, 1≤k≤n, using local analytic inputs (v_{k,1}^{j} . . . v_{k,l}_{ⱼ}^{j}) to produce an output wₖ^{j}, the following equation may be written:

A^{j}(v_{k,1}^{j}, . . . ,v_{k,l}_{ⱼ}^{j})=wₖ^{j}

Thus for each analytic A^{j} there may be multiple respective analytic outputs w^{j} corresponding to that analytic A^{j} being performed on multiple different endpoint devices. In the case where each of the n endpoint devices performs analytic A^{j}, the outputs produced are (w₁^{j}, w₂^{j}, . . . , wₙ^{j}) where 1≤j≤m.

Each endpoint device of the fleet will thus transmit to the server 402 analytic outputs for the respective analytics performed at that endpoint device. The analytics performed at one endpoint device in the fleet might be the same as or different to the analytics performed at another endpoint device in the fleet. In the case where an endpoint device performs all m analytics, the set of analytic outputs sent to the cloud server 420 by, say, endpoint device k, is (wₖ¹, wₖ², . . . , wₖ^{m}).

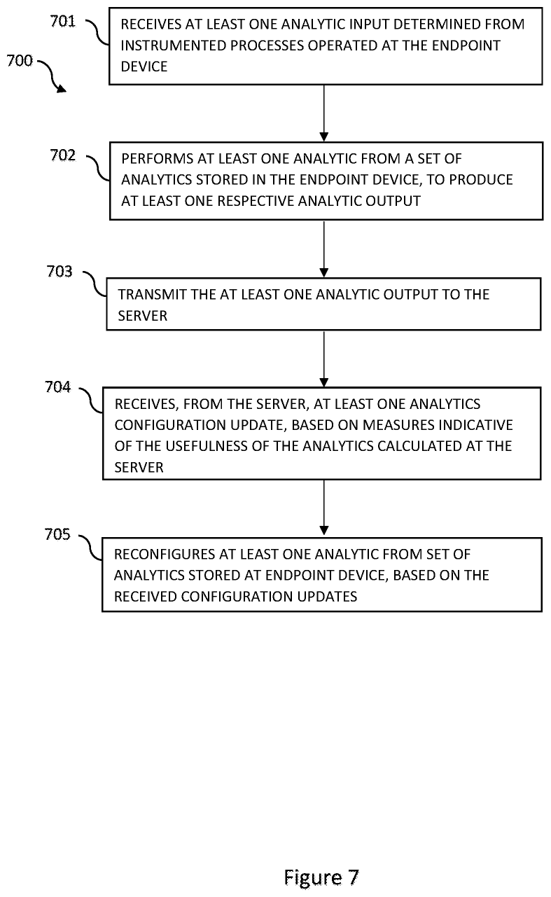

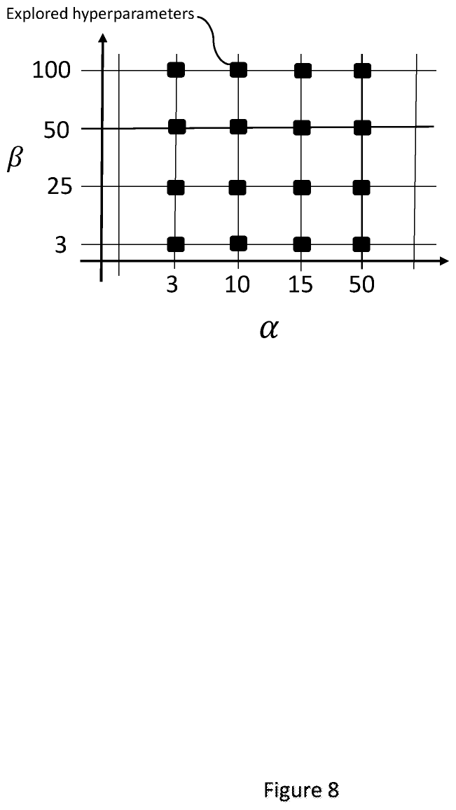

FIG. 6 is a flow diagram that outlines an example method 600, that may be carried out by the server 102 of the cloud computer system 100, to configure the analytics performed by the fleet of endpoint devices 110. The server may comprise at least one processor and a non-transitory computer readable medium storing instructions, which when executed by the at least one processor, causes the server to perform any part of the methods outlined below.

In 601 the server receives from each endpoint device in at least a subset of the fleet of endpoint devices, an analytic output of at least one respective analytic performed at that endpoint device.

Each analytic may be a function modelling as the analytic output a measure indicating an operational performance of the endpoint device based on at least one analytic input determined from instrumented processes operated at the endpoint device. Thus the server is able to receive periodically updated performance information from endpoint devices, effectively in “real-time”.

The server may, in addition to receiving the analytic outputs, further receive the analytic inputs from each endpoint device in each subset of endpoint devices that were used to perform those analytics at the endpoint device and produce the analytic outputs. By further receiving these respective analytic inputs with the analytic outputs the server may be able to analyse the usefulness of those analytic inputs. The server may, in addition to receiving the analytic outputs, further receive the analytic inputs and hyperparameter values from each endpoint device in each subset of endpoint devices that were used to perform those analytics at the endpoint device and produce the analytic outputs. Thus the server may also be able to analyse the usefulness of the hyperparameters and analytic inputs. The server may receive the outputs of all the configured analytics, the analytic inputs and the hyperparameters from endpoint devices the server has designated and configured as analytics calibration devices, for the purposes of assessing and calibrating the analytics to produce the analytics updates to the remaining devices in the fleet.

In 602 the server calculates, for each analytic for which analytic outputs are received, a measure indicative of the usefulness of performing the analytic in at least its current configuration in the fleet of endpoint devices using at least the received analytic outputs of the analytic;

It is sometimes the case that receiving analytic outputs in a given configuration, e.g. receiving all the available analytics from all the endpoint devices, is prohibitive, or that some analytics are providing less information than others. By calculating a measure indicative of the usefulness of performing the analytic, the server is able to learn whether the analytics are providing useful information and whether a different configuration of the analytics on the endpoint devices provides more useful information compared to the cost of producing those analytics. For example, on this basis, a further determination could be made by the server to have those less useful analytics performed on fewer endpoint devices or not performed at all.

The calculated measure indicative of the usefulness may be compared against a threshold for usefulness. The measure indicative of the usefulness of performing the analytic may be a utility function. The utility function calculated for each analytic may be formulated to weigh information gained from the analytic in a given configuration against a cost of the endpoint devices performing the analytic in a given configuration to thereby provide a measure indicative of the usefulness of the analytic in that given configuration;

The usefulness measure for an analytic in a given configuration may be calculated by evaluating a utility function for the function in that configuration, the utility function being formulated to provide a measure indicative of the usefulness of the analytic in a given configuration.

The utility function may be calculated by at least one of: calculating a measure of an information content of the analytic in a given configuration based on one or more of the received analytic outputs or received analytic inputs of the analytic received at the server from the endpoint devices and used to perform the analytic at the endpoint devices; calculating a measure of a processing cost for performing the analytic in a given configuration at the endpoint devices performing the analytic; calculating a measure of a bandwidth cost for transmitting the analytic outputs of the analytic from the endpoint devices performing the analytic to the server. Thus the utility function may provide a way to find a more optimal balance between the information gained from an analytic, and the processing and bandwidth costs associated with performing the analytic.

Calculating the measure of information content of the analytic in a given configuration may comprise at least one of calculating a variance or autocorrelation of analytic outputs of the analytic received from the endpoint devices, and calculating a covariance or correlation between the analytic outputs of the analytic received from the endpoint devices and the analytic outputs of another analytic received from the endpoint devices. Thus, the measure of the information content may detect whether any particular analytic is providing useful information, or whether two analytics are providing similar or highly related information, which might mean one of the two analytics is providing unnecessary or redundant information.

If analytic inputs relating to an analytic are received from endpoint devices, calculating the usefulness measure of the analytic in a given configuration may comprise calculating, based on the received analytic inputs, a measure of an information content of the analytic in its current configuration or alternative configurations for the analytic with different inputs of the analytic included or excluded from performing the analytic.

The analytics may be configured to operate in a modular manner, providing useful results even with only a subset of the possible analytic inputs the analytic can consume. It is sometimes the case that using a configuration involving a smaller or simpler set of analytic inputs for a given analytic results in an analytic output of similar accuracy or usefulness when compared to a configuration involving a larger or more complicated set of analytic inputs. For example, some of the analytic inputs may be adding little in the way of useful information to the analytic output. By calculating a measure of information content for performing the analytic with a given set of analytic inputs, the server may able to learn how the analytic inputs contribute to the value of the analytic output. On this basis, a more optimal configuration could be determined by changing the set of analytic inputs for performing a particular analytic.

If hyperparameter values relating to an analytic are received from endpoint devices, calculating the usefulness measure of the analytic in a given configuration may comprise calculating, based on the received analytic inputs, a measure of an information content of the analytic in its current configuration or a one or more alternative configurations for the analytic with different values for the hyperparameters of the analytic. That is, by testing the usefulness of the analytic in different possible configurations by choosing different values for hyperparameters of the analytic, the analytic may be reconfigured to improve its usefulness or reduce the cost of performing it.

In 603 the server determines, based on the calculated usefulness measure of each analytic, whether to change the configuration of the analytic performed in the fleet of the endpoint devices by at least one of changing the subset of endpoint devices performing the analytic and tuning how the analytic is performed by the subset of endpoint devices;

Changing the subset of endpoint devices performing the analytic may comprise at least one of stopping performing the analytic in a first subset of endpoint devices, and starting performing the analytic in a second subset of endpoint devices. Thus, on the basis of the calculated usefulness of an analytic, the performance of the analytic by endpoint devices in the fleet may be started or stopped, such that the number of endpoint devices performing that analytic may be reduced, increased, or kept the same. The analytic may be stopped or started in all endpoint devices other than the analytics calibration subset of endpoint devices (which are configured to perform all of the analytics all of the time).

For less useful analytics, a reduction in the number of endpoint devices performing the analytic will reduce the costs associated with performing that analytic at the reduced number of endpoint devices, without reducing significantly the amount of useful information received by the server related to that analytic. For more useful analytics an increase in the number of endpoint devices may provide a significant increase in useful information received by the server related to that analytic, without too great a cost associated with performing that analytic at the increased number of endpoint devices.

Tuning how the analytic is performed by the subset of endpoint devices may comprises at least one of changing the analytic inputs used in performing the analytic, and changing a configurable hyperparameter of the model of the operational performance of the endpoint devices in the function implementing the analytic.

Changing the analytic inputs may include reducing or increasing the number of analytic inputs for performing the analytic, or may include selecting simpler or more complicated analytic inputs for performing the analytic. Thus, a reduction in the number or complicatedness of the analytic inputs used to perform an analytic may result in reduced overall processing costs associated with performing that analytic at the endpoint devices and in reduced bandwidth costs of sending analytic inputs to the cloud server for analysis of that analytic. Conversely, an increase in the number or complicatedness of the analytic inputs used to perform an analytic may result in more accurate or useful analytic outputs for that analytic being produced at the endpoint devices and thus an improvement in the overall performance of that analytic, which may, for example, be improved malware detection.

If analytic inputs relating to an analytic are received from endpoint devices, the server determining whether to change the configuration of the analytic may comprise determining to change the analytic inputs used in performing the analytic in at least a subset of endpoint devices based on a feature selection routine for selecting the inputs for the analytic using the usefulness measure to evaluate the usefulness of the inputs.

Changing the configurable hyperparameter will change how the analytic is performed by the endpoint devices, and may as a result, lead to either an improvement in the overall performance of the analytic or reduced processing costs associated with performing the analytic at the endpoint devices.

If hyperparameter values relating to an analytic are received from endpoint devices, determining whether to change the configuration of the analytic may comprise determining to change a configurable hyperparameter of the model of the operational performance of the endpoint devices in at least a subset of endpoint devices based on a grid search for selecting the hyperparameter values for the analytic using the usefulness measure to evaluate the usefulness of the analytics having those hyperparameter values.

In 604 the server transmits an analytics configuration update to at least a subset of endpoint devices, based on the determined changes to reconfigure the analytics performed on the endpoint devices. This causes the configuration of analytics performed by the fleet of endpoint devices to be changed based on the determining 603.

The server may further transmit an analytics calibration device designation message to a designated analytics calibration subset of endpoint devices, to cause the devices in the analytics calibration subset to send to the server at least one of: an analytic output of all analytics provided on the device, irrespective of analytics determined by the server to be stopped; the analytic inputs that can be used to perform those analytics at the device and produce the analytic outputs also sent to the server; or the configuration of the hyperparameters of the model of the operational performance of the endpoint devices used in the function implementing the analytic.

By designating an analytics calibration subset, only a small portion of the endpoint devices are required to perform all the configured analytics to allow the server to assess their utility across the whole fleet. In this way, the cloud computer system may efficiently remain vigilant and responsive to the changing operational environment, even for analytics not currently performed by devices not in the calibration subset. For example, suppose analytic A¹ is deemed to currently fall below a threshold for usefulness, and so it is determined that endpoint devices (except for those in the calibration subset) should stop performing that analytic. However, at some point in the future, perhaps due to a change in the operational environment, such as the presence of new malware, analytic A¹ may become more useful again, and exceed a threshold for usefulness, as calculated by the server in 602. Designating a small analytics calibration subset of endpoint devices that will always monitor A¹ will thus enable the cloud computer system to continually assess A¹, and different configurations thereof for usefulness, and respond quickly to any such changes in the operational environment by configuring all of the endpoint devices to perform A¹ or a different configuration thereof.

Transmitting the analytics calibration device designation message to a designated analytics calibration subset of endpoint devices may comprise the server randomly selecting a subset of 20% or fewer of the endpoint devices of the fleet of endpoint devices to designate as the analytics calibration subset of endpoint devices and to send an analytics calibration device designation message. Alternatively, the server may randomly select a subset of the endpoint devices of the fleet of endpoint devices that lies within a different range, such as 15% or fewer, 10% or fewer, or 5% or fewer.

The analytics calibration subset of endpoint devices may be the same for each analytic. The choice of endpoint devices designated as the calibration subset may depend upon the specific considerations and properties of the endpoint devices. For example, some endpoint devices may be located nearer the cloud server or in a location with faster and more reliable communications, in which case such endpoint devices could be designated as analytics calibration endpoint devices. In another example, the endpoint devices may be stratified according to certain properties, such as hardware components, device type (laptop, printer, workstation etc.), and software version, and as such, the calibration subset may be chosen based on this stratification to cover a wide range of these properties.

The analytics calibration subset of endpoint devices may be randomly changed and periodically re-designated to spread the burden of performing all the analytics across different devices in the fleet.

The server may repeatedly perform the above receiving 601, calculating 602, determining 603 and transmitting 604 at intervals, to cause the configuration of analytics performed by the fleet of endpoint devices to be calibrated to adapt to changes in the operational environment of the endpoint devices over time. The repetition of any of the receiving 601, calculating 602, determining 603 or transmitting 604 may also be used to improve stability, by ensuring that any decision to change a configuration is more likely to be based on detecting a real change in the operational environment at the endpoint devices, rather than being based on a one-off error or blip.

FIG. 7 is a flow diagram that outlines a method 700, carried out by an endpoint device, for configuring analytics performed by a fleet of endpoint devices, and is a counterpart to the methods outlined above carried out by the server. The features described above relating to FIG. 6 may apply equally to the method carried out by the endpoint devices, where appropriate.

The endpoint device carrying out the method may comprise at least one processor and a non-transitory computer readable medium storing instructions, which when executed by the at least one processor, causes the endpoint device to perform any part of the methods outlined below.

In 701 the endpoint device receives at least one analytic input determined from instrumented processes operated at the endpoint device. That is, in the device, one or more processes in any part of the software stack implemented on the device may be instrumented to provide as an analytic input data indicative of the operational performance of that process in or by the device. That is, processes forming part of, for example, the firmware, operating system, middleware, database or application software may be instrumented, for example, to sense and log events occurring in the device, parameter values, or other outputs at the source code level or binary level of the processes.

In 702 the endpoint device performs at least one analytic of a set of analytics stored in the endpoint device, to produce a respective analytic output. The analytic is performed based on the current configuration for that analytic, including any changes to configuration caused by configuration updates received from the server.

Each analytic may be a function modelling as the analytic output a measure indicating an operational performance of the endpoint device based on at least one of the analytic inputs.

In 703 the endpoint device transmits the at least one analytic output to the server.

In 704 the endpoint device receives from the server, at least one analytics configuration update, based on measures indicative of the usefulness of the analytics calculated at the server (as in 602 to 604) to reconfigure at least one of the set of analytics stored in the endpoint device.

The measure indicative of the usefulness of the analytics may be a utility function.

In 705 the endpoint device reconfigures, based on a received analytics configuration update, at least one of the set of analytics by at least one of stopping or starting performing the analytic, and tuning how the analytic is performed.

The endpoint device may, in tuning how the analytic is performed, change at least one of the analytic inputs for performing the analytic and a configurable hyperparameter of the model of the operational performance of the endpoint device in the function implementing the analytic.

The endpoint may further receive from the server an analytics calibration device designation message, which contains instructions for the endpoint device to send to the server at least one of: an analytic output of all analytics provided on the device, irrespective of analytics determined by the server to be stopped; the analytic inputs used to perform those analytics at the device and produce the analytic outputs also sent to the server; or the configuration of the hyperparameters of the model of the operational performance of the endpoint devices used in the function implementing the analytic. By sending to the server the output of all of the analytics performed at the device, together with all of the inputs consumable by all of the analytics and the hyperparameter values, the server can assess whether changes to the configuration of the analytic will improve its usefulness and/or reduce the cost of the analytic, balancing one against the other to optimise all the analytics across the fleet.

A cloud system comprises a server that may perform any part of the methods related to FIG. 6 in communication with a fleet of endpoint devices that may perform any part of the methods related to FIG. 7.

To illustrate the methods outlined above, three specific case examples will now be outlined, each showing different ways to change the configuration of the analytic performed in the fleet of the endpoint devices.

In these three case examples, the following two example analytics are used for illustrative purposes only, and are not intended to place any limitations on the type of analytic that could be performed by the fleet of endpoint devices.

### Example Analytic 1 (A¹)

This example A¹ is designed to detect periodic network requests as a potential indicator of malware, by observing a rolling time window of a network request signal. There are 5 input signals as inputs to the analytic, (v₁¹, v₂¹, v₃¹, v₄¹, v₅¹) upon which A¹ operates, to produce output w¹. The inputs are defined as follows:
v₁¹=autocorrelation of network request signal at time lag 1
v₂¹=autocorrelation of network request signal at time lag 2
v₃¹=autocorrelation of network request signal at time lag 3
v₄¹=autocorrelation of network request signal at time lag 4
v₅¹=score [0,1] based on rolling mean of signals (v₁¹, v₂¹, v₃¹, v₄¹)
   For v₅¹, the score lies in the interval [0,1] such that the less the rolling mean changes over time for some v₁¹, the higher the score, and the more it changes, the lower the score. The analytic A¹ acts on the inputs (v₁¹, v₂¹, v₃¹, v₄¹, v₅¹) as follows, to produce output w¹, which lies in the range [0,1]:

w¹=A¹(v₁¹,v₂¹,v₃¹,v₄¹,v₅¹)=(1−(min p-value of {v₁¹,v₂¹,v₃¹,v₄¹})+v₅¹)/2

The higher the output value w¹ is, the more likely it indicates the presence of malware.

### Example Analytic 2 (A²)

This example A² is designed to detect low diversity in transferred network bytes to a given hostname and thereby detect possible malicious behaviour. There are 3 input signals, (v₁², v₂², v₃²) upon which A² operates, to produce output w². The inputs are defined as follows:
v₁²=standard deviation of transferred bytes
v₂²=mean of transferred bytes
v₃²=number of days user visited hostname in past 7 days
   The analytic A² acts on the inputs (v₁², v₂², v₃²) as follows, to produce output w¹:
w²=A²(v₁², v₂², v₃²)=likelihood of malicious behaviour as per a machine learnt decision tree
   The higher the output value w², the more likely that malicious behaviour has been detected.

Three case studies are now set out, using the above two example analytics A¹ and A², showing different ways of changing the configuration of the analytics A¹ and A² performed in a fleet of endpoint devices. The first case study is an example of using the analytic outputs of analytics A¹ and A² to determine a subset of endpoint devices to perform analytics A¹ and A². The second case study is an example of changing the subset of endpoint devices performing analytics A¹ and A². The first case study is an example of changing the subset of endpoint devices performing analytics A¹ and A².

Case 1: Selecting Optimal Subset of Endpoint Devices Using Analytic Outputs:

For each endpoint device in a fleet of n endpoint devices, output pairs from A¹ and A² are collected i.e. {(w₁¹, w₁²), (w₂¹, w₂²), . . . , (wₙ¹, wₙ²)}. Offline analysis has shown, for example, that it takes roughly 3 times as many CPU cycles on average to produce w_{*}² compared to w_{*}². It is understood that other metrics may be used to compare w¹ and w². Note that any suitable approach for constructing a utility function for an analytic can be adopted that, for example, measures the information gained from an analytic and/or weighs it against the cost of producing that analytic in absolute terms or in relative terms compared to another analytic. An example utility function below could be used to determine a measure of usefulness for A¹ and A².

Case 1, example 1: An example utility function U(w_{*}¹) may be defined as:

U(w_{*}¹)=Max(1−|3*correlation(w_{*}¹,w_{*}²)|,0)

The total utility function may be the sum or the average of U(w_{*}¹). Note also a corresponding utility function could be used for U(w_{*}²). As the correlation increases, the utility function decreases and is weighted by the cost of processing A¹, so in this case only a small correlation will be tolerated before the weighting takes over. For increased stability, U is repeatedly measured over numerous time periods to ensure that any decision to discard A¹ (or A²) is more likely to be based on detecting a real change in the operational environment at the endpoint devices, rather than being based on a one-off error or a blip.

Case 1, example 2: Suppose A² above outputs a classification [0,1] instead of a likelihood (i.e. is Boolean). A utility function for w² could be defined as:

U(w_{*}²)=Var(w_{*}²)=p(1−p)

where p is the measured probability of A² outputting 0 (or 1). Thus if the analytic produces the same output time and time again, this decreases the variance, and so too does the utility function, which might indicate that A² is no longer producing useful information, and so becomes a candidate for discarding.

Case 2, Selecting Optimal Subset of Analytic Inputs:

There may be many ways to assess the effectiveness of analytic inputs v₁¹, v₂¹, v₃¹, v₄¹, v₅¹ in A¹. One way to assess the performance of each analytic input is by fitting them to a linear model. For example, if n endpoint devices are each performing A¹ using analytic inputs (v₁¹, v₂¹, v₃¹, v₄¹, v₅¹) and each producing a respective analytic output w¹, the correlation between vᵢ¹ and w¹ may be expressed as follows:

corr(vᵢ¹,w¹)=E((vᵢ¹−mean(vᵢ¹))*(w¹−mean(w¹))/std(vᵢ¹)*std(w¹)

where E denotes expectation and std denotes standard deviation. Here the mean, standard deviation, and expectation are calculated using corresponding values of vᵢ¹ and w¹ received from the n endpoint devices. This correlation can be then converted to an F statistic and a p-value as per an F-distribution, to give U(vᵢ¹)=(1−p(vᵢ¹)), where p is the p-value. If U(vᵢ¹) falls below a threshold, then vᵢ¹ could be removed as an analytic input for performing A¹.

This reduces the overhead of having to calculate some autocorrelations, aggregation statistics and their corresponding p-values when performing A¹. Therefore, a reduction in processing overhead at the endpoint device will occur. In addition, the F-statistic indicates that similar results will be obtained without using vᵢ¹ to perform A¹, and so a similar analytic output will likely be obtained with a clear reduction in performance overhead.

Case 2, example 2: In a more sophisticated example encoding a notional cost of processing, using the above setup but with the following weighting:

U(vᵢ¹)=(1−cost(vᵢ¹))*(1−p(vᵢ¹)),

where p(vᵢ¹) is as above, and cost(vᵢ¹) lies in the range [0,1] and may be human determined (or calculated based on instrumenting CPU cycles) and increases towards 1 as the cost in CPU cycles increases.

Case 2, example 3: A trained decision tree may be applied to example 2, in which the frequency that new samples (vᵢ¹, w¹) are passing through different branches of the tree may be measured. Subsections of the tree may be deleted if, say, a particular portion of samples are no longer passing through a tree's branch.

Case 3, Selecting Optimal Hyperparameters:

If it is determined by the server to update the hyperparameters for an analytic, this is pushed out to all endpoint devices performing the analytic, but still periodically the calibration subset of endpoint devices send their analytic inputs and analytic outputs (as with Case 2) and, optionally, their currently configured hyperparameters and with these received analytic data a grid search can be performed by the server over the hyperparameter space to optimise the analytic. An example of such a grid search is shown in FIG. 8, and is set in more details below as follows:
1. A Random subset of endpoint devices is selected from the fleet of n endpoint devices, to send the respective analytic inputs as well as its output, to the cloud server(s). For example, 10% of endpoint devices of the fleet may be randomly selected as the calibration subset to send (v₁^{j}, . . . , vₗ_{ⱼ}^{j}), w^{j}, and relevant hyperparameters.
   The hyperparameters are the configurable parameters of the model. For example, in a neural network, configurable parameters might include the depth of the network and any regularisation parameters, etc.
   For a decision tree, the configurable parameter may be the maximum depth of the tree.
   Most machine learning models in the popular scikit-learn library contain a getparams( ) method which returns the list of possible hyperparameters for the chosen model. For custom analytics, hyperparameter options can also be determined.
2. This is made possible as the communications between the endpoint devices and the cloud server is two-way. The cloud server may request enough data from the endpoint devices to be able to make statistically significant deductions.
3. In the cloud server, a grid search is applied over the received data (v,w) over the 10% of devices for alternate hyperparameter choices by:
   Following a standard machine learning (ML) procedure, divide the received dataset, train and test a model for the analytic with different hyperparameter choices against the analytic input data.
   Select the optimal trained model for the analytic based on relevant machine learning metrics for the given model (precision, recall, accuracy, cross entropy, MSE, etc) via the grid search.
4. To decide whether a change the hyperparameter for performing the analytic at the endpoint devices, the performance in 3. above of the current hyperparameter is compared to a new proposed hyperparameter found in 3. above. This is where the utility function comes in.
   As an example, the utility function can trade off the expected gain in the usefulness of the analytic versus the expected increase in performance overhead from the proposed change in hyperparameters for performing the analytic.
   On the test data, it may be timed how long and the difference in memory requirements when performing inference of the analytic output for the analytic with the current versus proposed hyperparameter values.
   The proposed hyperparameter values are either accept or rejected based on weighing the performance increase versus the change in processing requirements in changing to the proposed hyperparameters
5. Inform all endpoints devices to modify their hyperparameter as per the optimal choice found in 3. and 4. above by transmitting an analytics configuration update.
6. Repeat from 1.

To illustrate this, FIG. 8 shows two hyperparameters α and β of a neural network that, and for example both take positive integer values: α∈{1, 2, . . . }, β∈{1,2, . . . }.

As an example, a random forest classifier CLF may be used with hyperparameters of interest α,β, where α represents the number of (decision) trees in the ensemble and β the maximum depth of each tree. This can be denoted by CLF_{α}^{β}.

Reasonable choices of α,β to explore are made, such as: α∈{3,10,15,50}, β∈{10,25,50,100}. The cartesian product, α×β, is taken and the model is trained and evaluated for each choice of (α,β) in the grid.

If the current values of α,β being used to perform an analytic are 50 and 25 respectively, then CLF₅₀²⁵ is trained and tested on the collected data (v,w), and compared against the other 4×4−1=15 models as defined by the hyperparameters. Hyperparameters are then chosen for performing the analytic as outlined above to identify and change the analytic to the optimal hyperparameters.

1. A method for configuring, by a server, analytics performed by a fleet of endpoint devices, the method comprising:
receiving, at the server, from each endpoint device in at least a subset of the fleet of endpoint devices, an analytic output of at least one respective analytic performed at that endpoint device;
calculating, for each analytic for which analytic outputs are received, a measure indicative of the usefulness of performing the analytic in at least its current configuration in the fleet of endpoint devices using at least the received analytic outputs of the analytic;
based on the calculated usefulness measure of each analytic, determining, for each analytic, whether to change the configuration of the analytic performed in the fleet of the endpoint devices by at least one of changing the subset of endpoint devices performing the analytic and tuning how the analytic is performed by the subset of endpoint devices; and
transmitting an analytics configuration update to at least a subset of endpoint devices, based on the determined changes to reconfigure the analytics performed on the endpoint devices.

2. The method of claim 1, wherein changing the subset of endpoint devices performing the analytic comprises at least one of stopping performing the analytic in a first subset of endpoint devices starting performing the analytic in a second subset of endpoint devices

3. The method of claim 1, wherein each analytic is a function modelling as the analytic output a measure indicating an operational performance of the endpoint device based on at least one analytic input determined from instrumented processes operated at the endpoint device, and wherein
tuning how the analytic is performed by the subset of endpoint devices comprises at least one of changing the analytic inputs used in performing the analytic and changing a configurable hyperparameter of the model of the operational performance of the endpoint devices in the function implementing the analytic.

4. The method of claim 1, wherein the usefulness measure for an analytic in a given configuration is calculated by evaluating a utility function for the function in that configuration, the utility function being formulated to provide a measure indicative of the usefulness of the analytic in a given configuration and being calculated by at least one of:
calculating a measure of an information content of the analytic in a given configuration based on one or more of the received analytic outputs or received analytic inputs of the analytic received at the server from the endpoint devices and used to perform the analytic at the endpoint devices;
calculating a measure of a processing cost for performing the analytic in a given configuration at the endpoint devices performing the analytic;
calculating a measure of a bandwidth cost for transmitting the analytic outputs of the analytic from the endpoint devices performing the analytic to the server.

5. The method of claim 4, wherein calculating the of information content of the analytic in a given configuration comprises at least one of:
calculating a variance or autocorrelation of analytic outputs of the analytic received from the endpoint devices;
calculating a covariance or correlation between the analytic outputs of the analytic received from the endpoint devices and the analytic outputs of another analytic received from the endpoint devices.

6. The method of claim 1, further comprising:
receiving, at the server, from each endpoint device in at least a subset of the fleet of endpoint devices, the analytic inputs used to perform those analytics at the device and produce the analytic outputs also sent to the server;
wherein calculating the usefulness measure of the analytic in a given configuration comprises calculating, based on the received analytic inputs, a measure of an information content of the analytic in its current configuration or alternative configurations for the analytic with different inputs of the analytic included or excluded from performing the analytic; and
wherein determining whether to change the configuration of the analytic comprises determining to change the analytic inputs used in performing the analytic in at least a subset of endpoint devices based on a feature selection routine for selecting the inputs for the analytic using the usefulness measure to evaluate the usefulness of the inputs.

7. The method of claim 1, further comprising:
receiving, at the server, from each endpoint device in at least a subset of the fleet of endpoint devices, the analytic inputs and hyperparameter values used to perform those analytics at the device in and produce the analytic outputs also sent to the server; and
wherein calculating the usefulness measure of the analytic in a given configuration comprises calculating, based on the received analytic inputs, a measure of an information content of the analytic in its current configuration or a one or more alternative configurations for the analytic with different values for the hyperparameters of the analytic; and
wherein determining whether to change the configuration of the analytic comprises determining to change a configurable hyperparameter of the model of the operational performance of the endpoint devices in at least a subset of endpoint devices based on a grid search for selecting the hyperparameter values for the analytic using the usefulness measure to evaluate the usefulness of the analytics having those hyperparameter values.

8. The method of claim 1, further comprising:
transmitting an analytics calibration device designation message to a designated analytics calibration subset of endpoint devices, to cause the devices in the analytics calibration subset to send to the server at least one of:
an analytic output of all analytics provided on the device, irrespective of analytics determined by the server to be stopped;
the analytic inputs that can be used to perform those analytics at the device and produce the analytic outputs also sent to the server; or
the configuration of the hyperparameters of the model of the operational performance of the endpoint devices used in the function implementing the analytic.

9. The method of claim 8, further comprising the server randomly selecting a subset of 20% or fewer of the endpoint devices of the fleet of endpoint devices to designate as the analytics calibration subset of endpoint devices and to send an analytics calibration device designation message.

10. The method of claim 1, further comprising the server repeatedly performing the receiving, the calculating, the determining and the transmitting at intervals, to cause the configuration of analytics performed by the fleet of endpoint devices to be calibrated to adapt to changes in the operational environment of the endpoint devices over time.

11. A method for configuring, by an endpoint device, analytics to be performed at the endpoint device the method comprising:
receiving at least one analytic input determined from instrumented processes operated at the endpoint device;
performing at least one analytic of a set of analytics stored in the endpoint device, to produce a respective analytic output;
transmitting the at least one analytic output to the server;
receiving, from the server, at least one analytics configuration update, based on measures indicative of the usefulness of the analytics calculated at the server, to reconfigure at least one of the set of analytics stored in the endpoint device; and
reconfiguring, based on a received analytics configuration update, at least one of the set of analytics by at least one of: stopping or starting performing the analytic; tuning how the analytic is performed.

12. The method of claim 11, further comprising:
receiving from the server an analytics calibration device designation message, and sending to the server at least one of:
an analytic output of all analytics provided on the device, irrespective of analytics determined by the server to be stopped;
the analytic inputs used to perform those analytics at the device and produce the analytic outputs also sent to the server; or
the configuration of the hyperparameters of the model of the operational performance of the endpoint devices used in the function implementing the analytic.

13. A server comprising at least one processor and a non-transitory computer readable medium storing instructions, which when executed by the at least one processor, cause the server to perform the method of claim 1.

14. An endpoint device comprising at least one processor and a non-transitory computer readable medium storing instructions, which when executed by the at least one processor, cause the endpoint device to perform the method of claim 11.

15. (canceled)
